(19) United States
(12) Patent Application Publication
(10) Pub. No.: US 2008/0163973 A1
(43) Pub. Date: Jul. 10, 2008

(54) Composite label and method of using same

(76) Inventor: Karen L. Euse, Miamisburg, OH (US)

Correspondence Address: Avery Dennison Corporation, 170 MONARCH LANE, MIAMISBURG, OH, 45342, US

(21) Appl. No.: 11/649,688

(22) Filed: Jan. 4, 2007

(51) Int. Cl. B65C 1/02

(52) U.S. Cl. 156/62; 156/250; 428/41.8

(57) ABSTRACT

There are disclosed embodiments of a composite label having first and second label sections on a release liner having first and second release liner sections. The first label section overhangs and captures the second release liner section(s) so that after the label and the second release liner section(s) are applied to a substrate, the second label section can be separated from the first label section without removing the second release liner section(s) from the substrate.

### BACKGROUND OF THE INVENTION

1. Field of the Invention

The embodiments relate to composite labels and methods of using same.

2. Brief Description of the Prior Art

A typical prior art application is illustrated in FIGS. 1 and 2. FIG. 1 shows a carton 30 which can have a suitable composite label generally indicated at 31 applied to its wide side 32. The composite label 31 includes a first label section 31a and a second label section 31b. It is frequently desired to place such cartons 30 on a shelf 35 so that the maximum numbers of cartons 30 can fit on the shelf, and yet, the labeling must be visible. Accordingly, the cartons 30 are not stacked flat because in that event all the labels 31 would not be visible. Instead, the cartons 30 are stacked vertically side-by-side as shown in FIG. 2 so that the ends 36 of the cartons 30 are visible. Before stacking, the label sections 31b are separated from the label sections 31a and are applied to the ends 36 of the cartons 30. In this way, the label sections 31b are clearly visible even though all the label sections 31a are not visible.

A prior art composite label web is generally indicated at 40 in FIGS. 3 and 4. The composite label web 40 includes a carrier web or release liner 41 to which labels 31 are releasably adhered by a uniform or “full gum” coating of pressure sensitive or tacky adhesive 43. The carrier web or release liner 41 has a release coating 41′ on its upper surface as viewed in FIGS. 3 and 5 so that the labels 31 can be manually peeled from the release liner 41. The release liner 41 has perforations 45 which enable the composite label web 40 to be stacked in a fan-fold arrangement. The perforations 45 divide the composite label web 40 into end-to-end connected composite labels generally indicated at 46. Lines of weakening, for example, perforations are shown in the drawings by dot-dot lines. Each composite label 46 includes one of the labels 31. A continuous generally U-shaped line of weakening 47 is shown in each label 31. The line of weakening 47 does not extend into the release liner 41 associated with each label 31. Each line of weakening 47 divides each label 31 into the first label section 31a and the second label section 31b. The lines of weakening 45 and 47 shown by dot-dot lines. The dot-dot lines shown in the drawings do not represent hidden lines. The second label sections 31b are capable of being separated from the first label sections 31a as is disclosed hereinafter. The release liner 41 is preferably completely severed as shown by elongate generally U-shaped dot-dash lines 48 to provide first and second release liner sections 41a and 41b. Although the line of weakening 47 and the line of severing 48 are paired but not aligned with each other, the lines 47 and 48 are registered with each other, with the labels 31 and with lines of weakening 45. The dot-dash lines in the drawing indicate hidden lines. As shown in FIG. 3, each second label section 31b is larger in lengthwise and widthwise dimensions and overhangs the respective associated entire second release liner section 41b, except for a short finger-engageable tab 41b′ shown at the right side of FIG. 3. As shown, the carrier web 41 has side edges 42 and 42′ which are more widely spaced than side edges 31′ and 31″ of the labels 31. Thus, the tabs 41b′ extend beyond the side edges 31″ of the labels 31 for ready finger access by the user. Adjacent labels 31 are also spaced slightly from the intervening line of weakening 45. The labels 31 are thus of the type known as “fully die cut” because label material surrounding the labels 31 has been stripped away during the manufacturing process.

FIG. 5 shows a section through the label 31a, the adhesive 43, the release material such as silicone 41′ and the release liner 41.

The composite label web 40 can be fed through and printed in a bar code printer. The label sections 31a and 31b of a label 31 can have some or all of the same printed information. FIG. 6 for example shows the label sections 31a and 31b printed with both bar codes and text.

The labels 31 can be manually peeled from the liner 41 and applied to a carton or other substrate as desired. FIG. 6 shows the label 31 adhered by the pressure sensitive adhesive 43 to a substrate S such as the carton 30. The second label section 31b and the tab 41b′ can be manually grasped and pulled to tear off the second label section 31b and the second liner section 41b along the line of weakening 47. Initiation of such tearing off is facilitated by the tab 41b′.

FIG. 7 shows that the second label section 31b and the second release liner section 41b have been removed from the first label section 31a and the first release liner section 41a.

FIG. 8 depicts the removed second label section 31b and the second release liner section 41b adhered thereto on the underside of the second label section 31b.

FIGS. 9 and 10 show, respectively, the second label section 31b and the second release liner section 41b having been peeled off the second label section 31b. Thereupon, the second label section 31b can be applied to the carton 30 as shown in FIG. 1. Because the second label section 41b is now a loose piece, it is required to be discarded. So for each label section 31b from which a release liner section 41b has been peeled, it is required that the release liner section 41b be properly disposed of, for example, into a container. Because the release liner section is silicone coated and slippery, it should not simply be discarded onto the floor.

### SUMMARY OF THE INVENTION

According to a specific embodiment, there is provided a composite label comprising a label having a coating of pressure sensitive adhesive on its underside, the label having a first label section and a second label section defined by at least one line of weakening, at least one release liner section against only a portion of the adhesive so that adhesive beyond the release liner section(s) may adhere the label to a substrate, the release liner section(s) underlying at least a part of the second label section, the first label section overhanging and capturing only a portion of the second release liner section(s), and wherein the second label section may be separated from the first label section without removing the first label section or the release liner section(s).

According to a specific embodiment there is provided a composite label comprising a release liner having a first release liner section and at least one second release liner section, a label releasably adhered by pressure sensitive adhesive to the first and second release liner sections, the label having separable first and second label sections, and the first label section overhanging and capturing at least a portion of at least one second liner section.

According to a specific embodiment there is provided a composite label comprising a label having a coating of pressure sensitive adhesive and divided at least into a first label section and a second label section removable with respect to the first label section, and at least one release liner section under at least part of the second label section and captive under only a part of the first label section.

According to a specific embodiment there is provided a composite label web comprising a longitudinally extending release liner, labels releasably adhered by pressure sensitive adhesive along the length of the release liner, the release liner being severed in registry with each label to divide the release liner beneath each label into a first release liner section and at least one second release liner section, each label being at least partially severed to divide each label into at least a first label section and a second label section removable from the first label section, wherein the longitudinal extent of at least a part of one second release liner section is greater than the longitudinal extent of the second label section, wherein when the first release liner section has been removed from the label, and the label and the second release liner section(s) have been applied to a substrate, the second label section is removable without removing the second release liner section(s).

According to a specific embodiment there is provided a method of using a composite label which includes providing a composite label including a release liner having a first release liner section and at least one second release liner section wherein the first release liner section is substantially severed from the second liner section(s), and a label releasably adhered by pressure sensitive adhesive to the first and second release liner sections, the label having separable first and second label sections, the first label section overhanging only a portion of the second liner section(s), printing information on the first and second label sections, removing the first release liner section to expose adhesive beneath a part of the first label section, attaching the label and the at least one second liner section to a substrate, and thereafter removing the second label section but retaining the at least one second liner section captured by the first label section.

According to a specific embodiment there is provided a method of using a composite label web which includes providing a label on a release liner having a first liner section and at least two second release liner sections, the label being releasably adhered by pressure sensitive adhesive to the first release liner section and the at least two second release liner sections, the label having at least first and second separable label sections, the first and second release liner sections being at least substantially severed from each other, separating the label and the second release liner section from the first release liner section in a label applicator, applying the label and the second release liner sections to a substrate, and thereafter removing the second label section from the substrate without removing the second release liner sections.

According to a specific embodiment there is provided a method of using a composite label web which includes providing a label on a release liner having a first liner section and at least one second release liner section, the first and second release liner sections all being severed from each other, the label being releasably adhered by pressure sensitive adhesive to the first and second release liner sections, the label having at least first and second separable label sections, separating the label and the second release liner section(s) from the first release liner section in a label applicator, applying the label and the second release liner section(s) to a substrate, and thereafter removing the second label section from the substrate without removing the second release liner section(s).

### BRIEF DESCRIPTION OF THE DIAGRAMMATIC DRAWINGS

FIG. 1 is a pictorial view of a box or carton with a prior art composite label adhered to a side face thereof;

FIG. 2 is a pictorial view of cartons arranged on a shelf, with label sections having been removed from the prior art composite labels and applied to front ends of the cartons;

FIG. 3 is a top plan view of a prior art composite label web;

FIG. 4 is a bottom plan view of the prior art composite label web shown in FIG. 3;

FIG. 5 is a sectional view taken along line 5-5 of FIG. 3;

FIG. 6 is a top plan view of a prior art label and an underlying release liner section applied to a substrate;

FIG. 7 is a top plan view similar to FIG. 6 but showing a label section of the label having been removed together with an underlying release liner section;

FIG. 8 is a top plan view of the label section and the release liner section referred to above in connection with FIG. 7;

FIG. 9 is a pictorial view of the label section referred to above in connection with FIGS. 7 and 8;

FIG. 10 is a pictorial view of the release liner section referred to above in connection with FIGS. 7 and 8;

FIG. 11 is a top plan view of the composite label web according to a new embodiment;

FIG. 12 is a bottom plan view of the new composite label web also shown in FIG. 11;

FIG. 13 is a top plan view of the new label and release liner sections applied to a substrate;

FIG. 14 is a bottom view of the label and release liner sections shown in FIG. 13;

FIG. 15 is a top plan view of the label with one label section and a tab-like third release liner section or tab removed;

FIG. 16 is a top plan view of a label section and the tab;

FIG. 17 is a bottom view of the label section and its tab shown in FIG. 16;

FIG. 18 is fragmentary top plan view of another new embodiment of a composite label web useful in being printed and in which its labels can be applied in a printer applicator;

FIG. 19 is a diagrammatic side elevational view of a label printer applicator in which the labels can be printed and applied to a carton;

FIG. 20 is a top plan view of a fragmentary portion of a release liner from which chads or cutouts or second and third release liner sections have been removed;

FIG. 21 is a top plan view of a label which has been printed and applied to a substrate;

FIG. 22 shows the label of FIG. 21, but illustrating the chads that remain adhered to the underside of the label;

FIG. 23 is a bottom plan view of the label shown in FIG. 22;

FIG. 24 shows the label of FIG. 22 printed with bar codes and text;

FIG. 25 is a top plan view of a label section and a chad; and

FIG. 26 is a bottom plan view of the label section and a chad shown in FIG. 25.

### DETAILED DESCRIPTION OF THE PREFERRED EMBODIMENTS

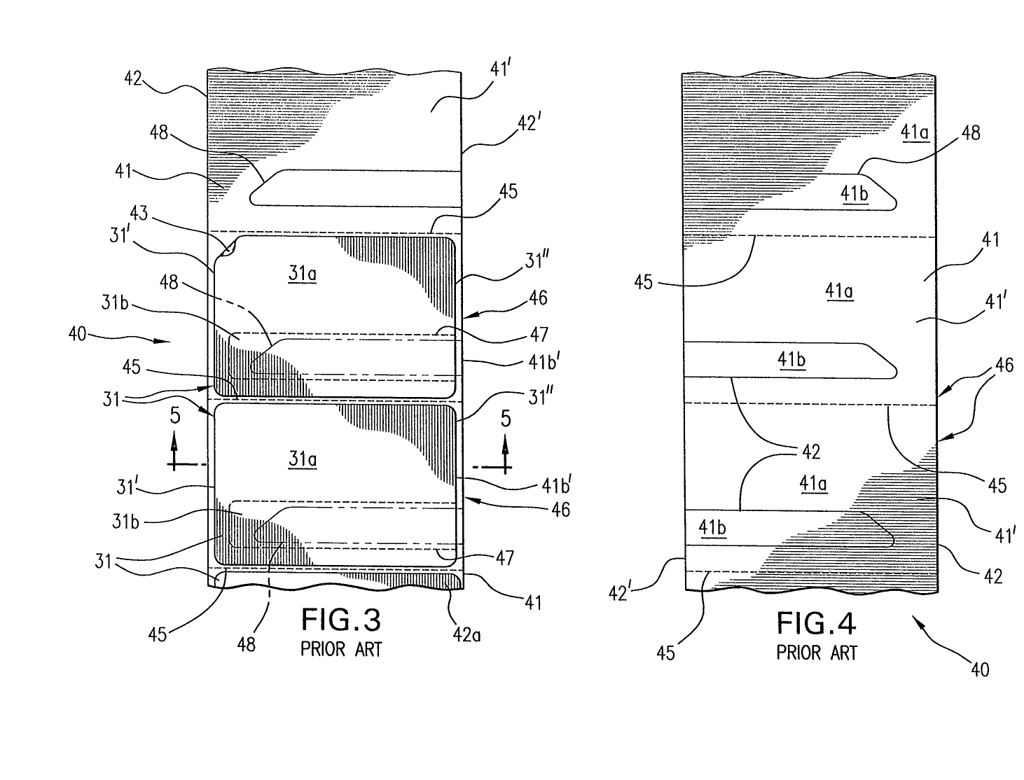

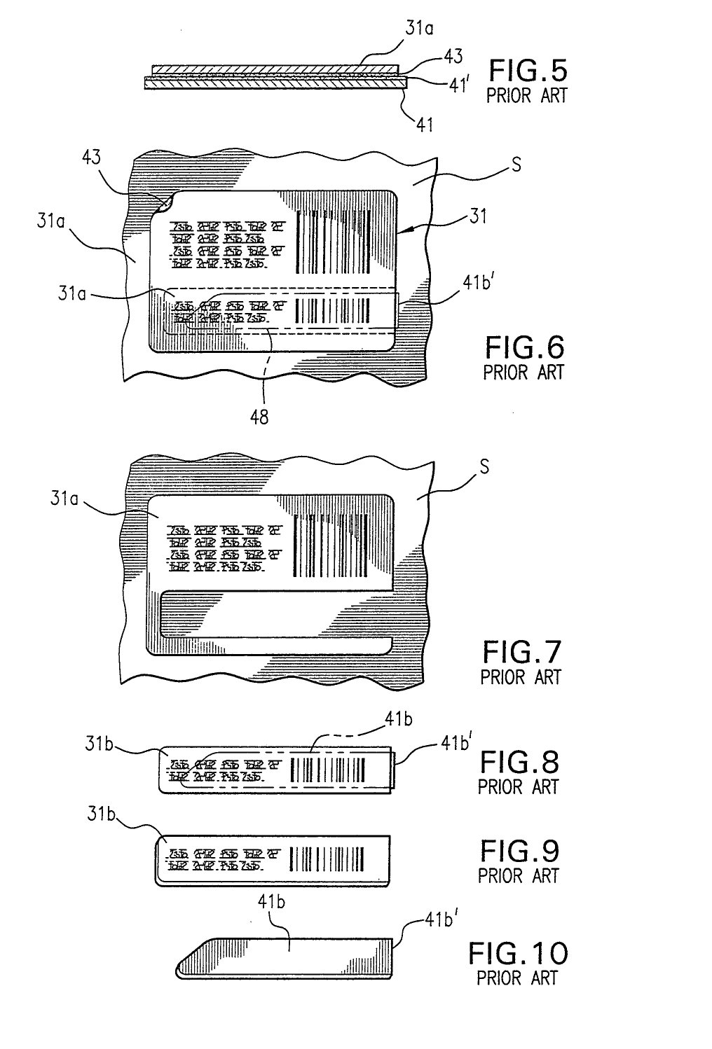

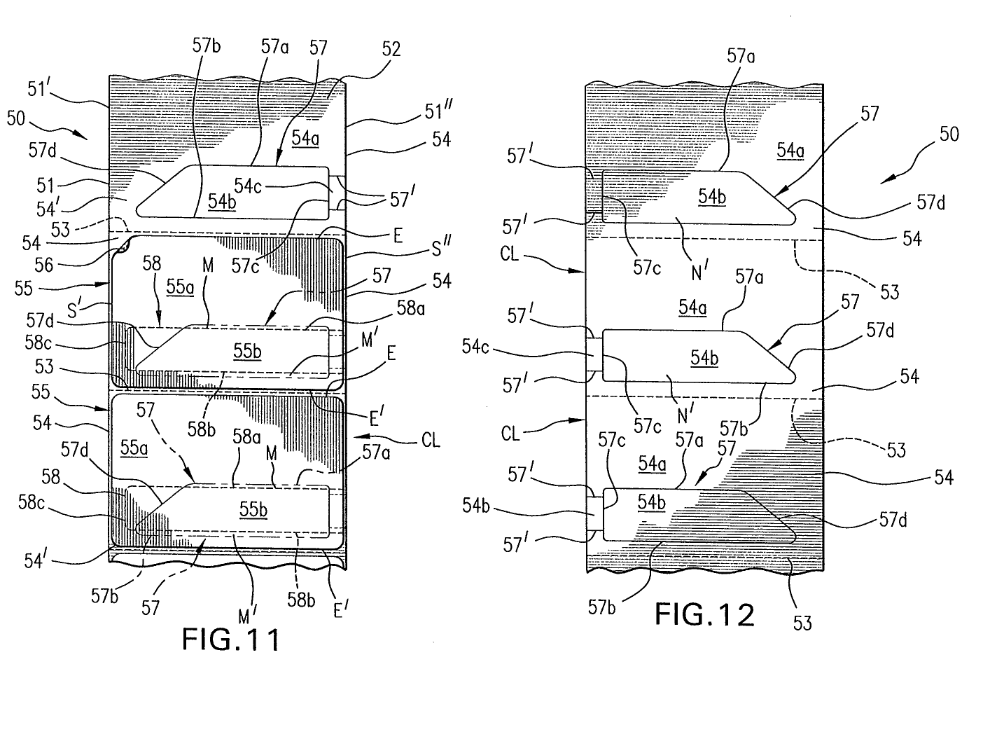

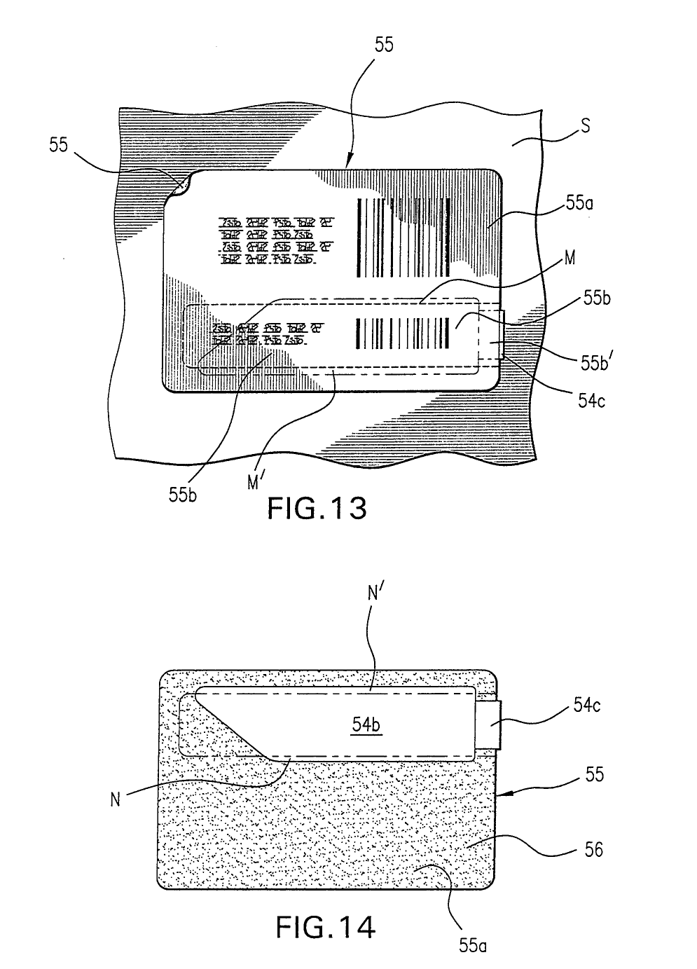

In a new and improved embodiment shown in FIGS. 11 through 17, and initially to FIGS. 13 and 14, there is shown a composite label web 50 which is an improvement over the composite label web 40 shown in FIGS. 3 and 4 for example.

The composite label web 50 is shown to include a longitudinally extending carrier web 51 having a release coating 52 such as silicone. The carrier web 51 is preferably divided at equally longitudinally spaced intervals by lateral or transverse lines of weakening 53 into connected release liner sheets 54. The lines of weakening 53 can be made by perforating or scoring, for example, so that the label web 50 can be fan-folded for use in a printer and/or the sheets 54 can be readily torn from the web 50. Alternatively, the lines of weakening 53 can be omitted and the release composite label web 50 can be wound into a roll and fed into a printer for printing on labels 55.

The labels 55 are shown to be fully die cut. The release liner web 51 has spaced longitudinally extending side edges 51′ and 51″. Adjacent leading and trailing end edges E and E′ of the labels 55 are shown to be spaced slightly from each other and from the intervening line of weakening 53. The labels 55 have side edges S′ and S″ which terminate short of the side edges 51′ and 51″ of the release liner 51. The labels 55 are releasably adhered by pressure sensitive or tacky adhesive 56 to the release coating 52 on the release liner 51, so that the labels 31 can be manually peeled off the release liner 51. The adhesive 56 is preferably a full gum or continuous or uniform adhesive coating along and across the entire underside of the label 55, however, a patterned adhesive can be used. Each label 55 and its related release liner sheet 54 is considered to comprise a composite label CL.

As shown by both dot-dash lines and solid lines in FIG. 11, release liner sections 54 are preferably completely severed at lines of severing 57 and 57′ to provide first release liner sections 54a, second release liner sections 54b and third release liner sections or tabs 54c. The lines of severing 57 are shown to make closed truncated quadrilateral shapes each having a pair of side lines of severing 57a and 57b, an end line of severing 57c perpendicular to and joining the side lines of severing 57a and 57b and an obliquely or laterally inclined line of severing 57d joining the side lines of severing 57a and 57b.

Each label 55 has a line of weakening 58, as by perforations, which divide the label 55 into a first label section 55a and a second label section 55b. The line of weakening 58 is preferably generally U-shaped, having lateral parallel weakening lines 58a and 58b joined to a longitudinal weakening line 58c. The weakening lines 58a and 58b extend to the side edges S″ of the labels 55. It is to be noted that the weakening lines 58a and 58b are more closely spaced than the severing lines 57a and 57b, and, thus, upper and lower margins M and M′ of the first label section 55a overhang the upper and lower margins or zones N and N′ (FIGS. 12 and 14) of the second release liner section 54b. The first label sections 55a, therefore, capture the margins N and N′ of the second release liner sections 54b.

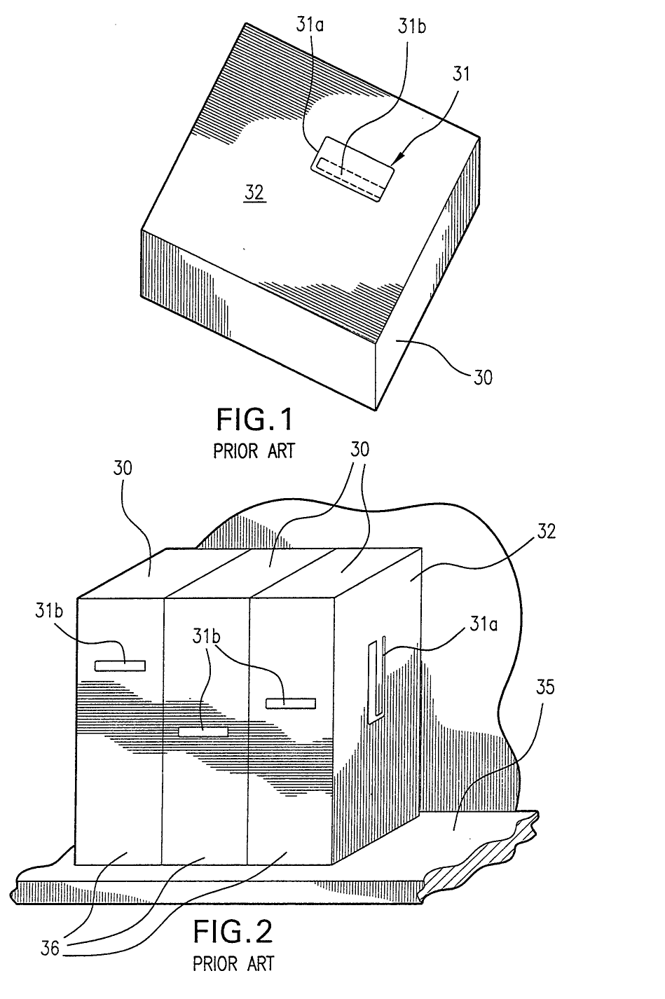

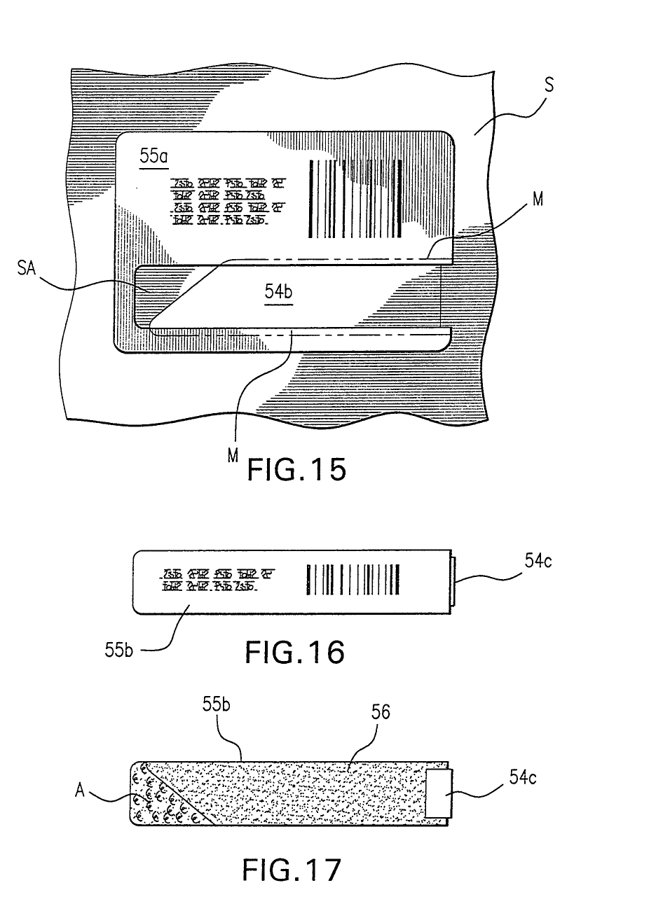

The composite label web 50 can be printed in, for example, a bar code printer to print bar codes, text and the like. FIG. 13 shows the label 55 as having been printed, removed from the release liner sheet 54 and adhesively adhered by the adhesive 56 to the substrate S. The substrate S can be a carton as depicted in FIG. 1. In order to separate the second label section 55b from the first label section 55a, the user grasps end portion 55b′ of the second label section 55b and the tab 54c between the thumb and index finger of one hand and progressively tears the second label section 55b from the first label section 55a. It is to be noted that the label section 55b can be torn progressively starting from the side edge S″ and along the lines of weakening 57a and 57b and then along the line of weakening 58c, but marginal edges or margins N and N′ of the release liner section 54b remain trapped beneath marginal edges or margins M and M′ of the first label section 55a. Therefore, the second label section 55b can be peeled from the second release liner section 54b without removing the second release liner section 54b. It is noted that because the first release liner section 54a was removed before the label 55 was adhered to the substrate S, part of the second label section 55b was actually adhered to a generally triangular area or zone SA of the substrate S as shown in FIG. 15. Thus, zone SA of the substrate S is visible in FIG. 15 between the first label section 55a and the second release liner section 54b. The margins M and M′ of the first label section overhang, capture and prevent the second release liner section 54b from being removed when the second label section 55b and the tab 54c are peeled from the second release liner section 54b and the area SA of the substrate S. As a result, as shown in FIG. 17, the adhesive 56 may pull some of the fibers from the substrate S (if for example, the substrate S is a cardboard box) and the fibers are illustrated as pigtail-shaped in an area A. The adherence of fibers to the adhesive 56 on the second label section 55b has essentially no effect upon the user being able to re-apply and adhere label section 55b, such as to a carton as shown in FIG. 1. The tab 54c likewise does not interfere with adherence of a re-applied label section 55b because of its the small area. The unused adhesive 56 on the portion of the second label section 55b outside the area A and outside the tab 54c can securely adhere the label 55b to the substrate S or the like. The second release liner section 54b protects the adhesive 56 until the label section 55b is removed and is reapplied.

Although the lines of weakening 58 and the lines of severing 57 and 57′ are grouped but not aligned with each other, the lines 57, 57′ and 58 are registered with each other, with the labels 55 and with the lines of weakening 53.

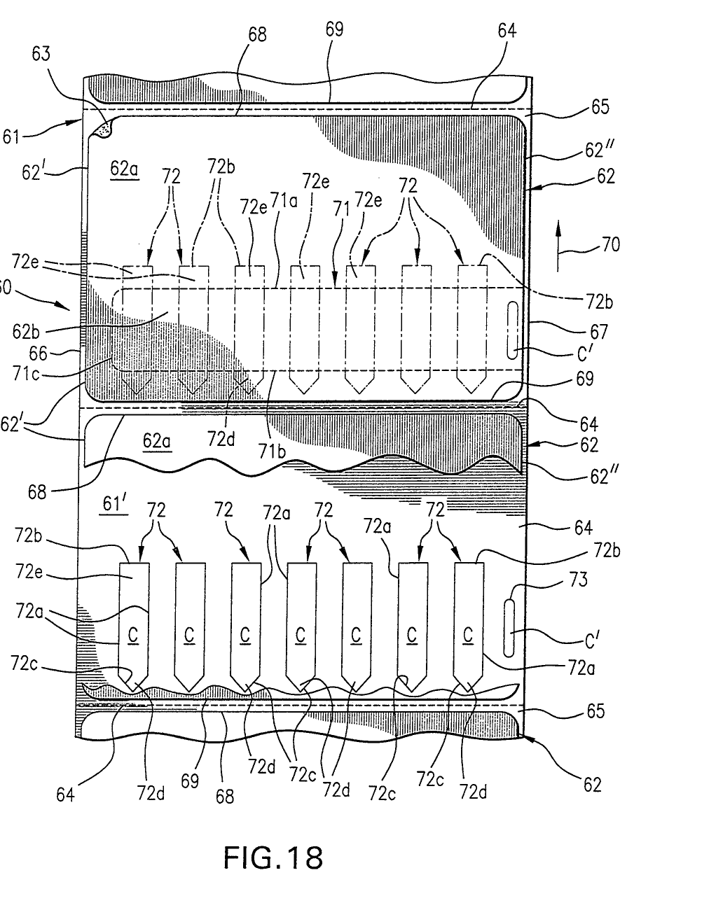

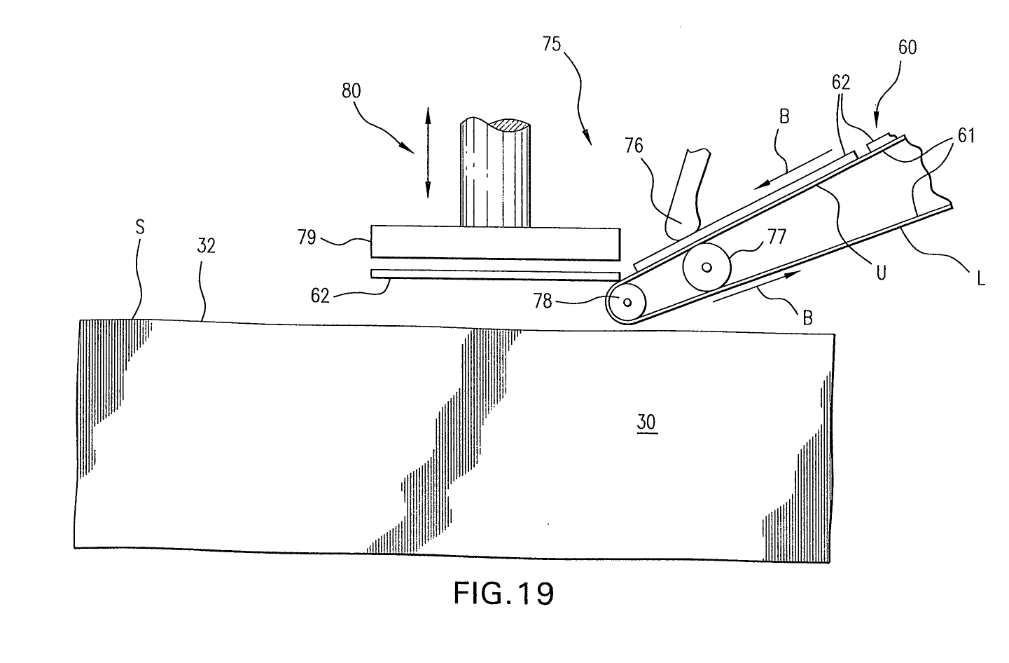

With reference to the new and improved embodiment of FIGS. 18 through 26 and initially to FIG. 18, there is shown a composite label web generally indicated at 60 comprised of a longitudinally extending carrier web or release liner 61 and labels 62 releasably adhered by pressure sensitive or tacky adhesive 63 to a release coating 61′ on the carrier web or release liner 61′. The release liner 61 may have lateral or transverse lines of weakening 64 at equally spaced longitudinal intervals to divide the release liner 61 into connected release liner sheets 65. The composite label web 60 can be fan-folded or rolled into a roll. Also the release liner sheets 65 can be torn apart at the lines of weakening. The lines of weakening 64 can be formed by perforation, scoring or the like. For a rolled web the lines of weakening 64 can be omitted, if desired. Each release liner sheets 65 carries a fully die cut label 62. Each label 62 and its related release liner sheet 65 is considered to comprise a composite label CL′. The labels 62 have opposite side edges 62′ and 62″ and the release liner 61 has opposite side edges 66 and 67. The side edges 62′ and 66 are spaced apart, and the side edges 62″ and 67 are spaced apart. The labels 62 have leading and trailing end edges 68 and 69, respectively. The composite label web 60 is intended to be fed in the direction of arrow 70.

Each label 62 has a line of weakening generally indicated at 71 by dot-dot lines. The line of weakening 71 is shown to be generally U-shaped. Each line of weakening 71 divides the label 62 into a first label section 62a and a second label section 62b. The weakening line 71 can be formed by perforating or scoring, for example. The line of weakening 71 extends in the label 62 but preferably not into the release liner 61. The line of weakening 71 includes longitudinally spaced, transverse, parallel lines of weakening 71a and 71b joined to a longitudinally extending line of weakening 71c. The lines of weakening 71a and 71b extend to the side edge 62″ of each label 62. As shown by solid lines at the location of the broken away label 62 and by dot-dash lines in the other label in FIG. 18, the release liner sections 65 have lines of severing indicated at 72 and 73 which define chads or release liner sections C and C′. The severing 73 and hence the chads C′ are very close to the side edge 62″ of the labels 62. Each line of severing 72 can have two parallel, spaced, longitudinally extending lines of severing 72a. Each pair of lines of severing 72a are joined at one end to a transverse line of severing 72b. Each pair of two parallel lines of severing 72a is joined to a pair of angle-shaped lines of severing 72c. The chads C and C″ are elongate and are shown to extend longitudinally. It is the labels 62 including their adhesive 63 that holds the chads C and C′ in the plane of the release liner 61 in the composite label web 60. As is apparent from FIG. 18, the chads C extend beyond the transverse severing line 71a toward the leading end 68 of the label 62 and beyond the transverse severing line 71b toward the trailing end 69 of the label 62. The transverse severing lines 72b are preferably transverse and most preferably perpendicular to the severing lines 72a. The angled severing lines 72c converge to a point and point toward the trailing end 69. The severing lines 72c form inclined end portions 72d. The first label section 62a overhangs and captures end portions 72d and 72e of the chads C. The chad C′ is shown to be completely beneath the second label section 62b.

With reference to FIG. 19, there is shown a printer applicator generally indicated at 75, the composite label web 60 and a carton 30. The printer applicator 75 includes a print head 76, a cooperating platen roll 77 and a delaminator 78. The print head 76 may be a thermal print head although any desired print head can be used. The composite label web 60 passes to between the print head 76 and the platen roll 77 where bar codes, text and/or other information can be printed. As the release liner 61 passes about the delaminator 78, the printed leading label 62 is delaminated and advanced in label applying relationship beneath a reciprocating applicator head or presser foot 79 of a label printer applicator generally indicated at 80. As the presser foot 79 descends, the leading label 62 beneath the presser foot 79 is pressed against and adhesively adhered to the substrate S, which in the illustrated example, is side portion 32 of the carton 30.

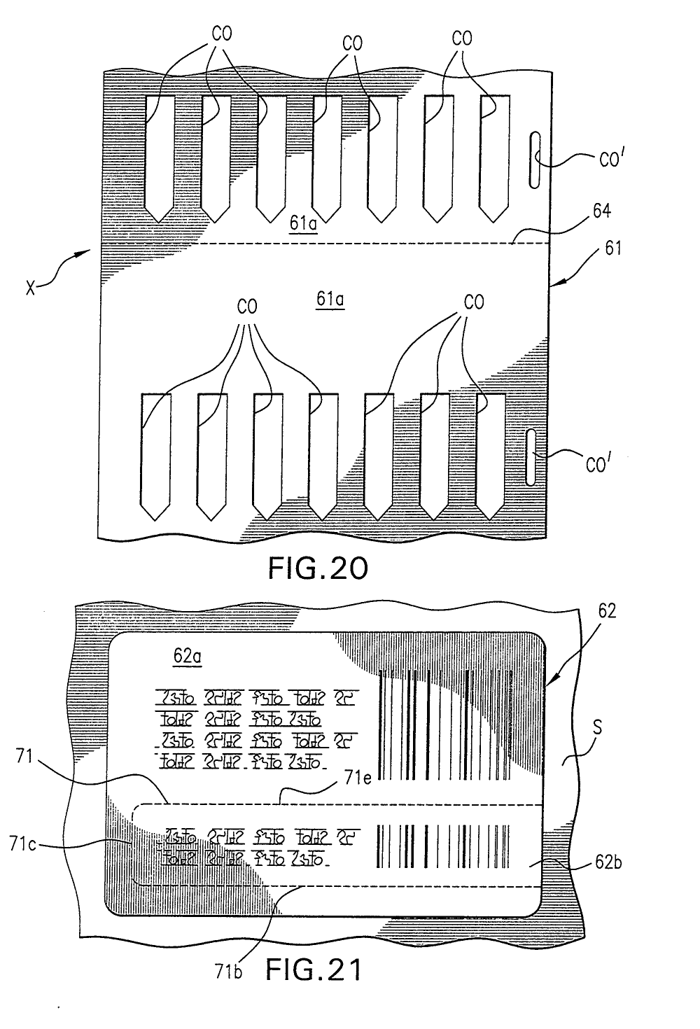

As shown in FIG. 19, the release liner 61 undergoes a bend at the delaminator 78 and has an upper pass U and a lower pass L. The labels 62 are delaminated together with the chads C and C′ by the delaminator 78. Accordingly, a top plan view of the lower pass L has the appearance shown in FIG. 20. FIG. 20 shows the chads C and C′ as having been removed from the release liner 61 as indicated by the shading. The chads C and C′ remain adhered to the underside of the label 62. Accordingly, the release liner 61 is left with holes or openings CO and CO′.

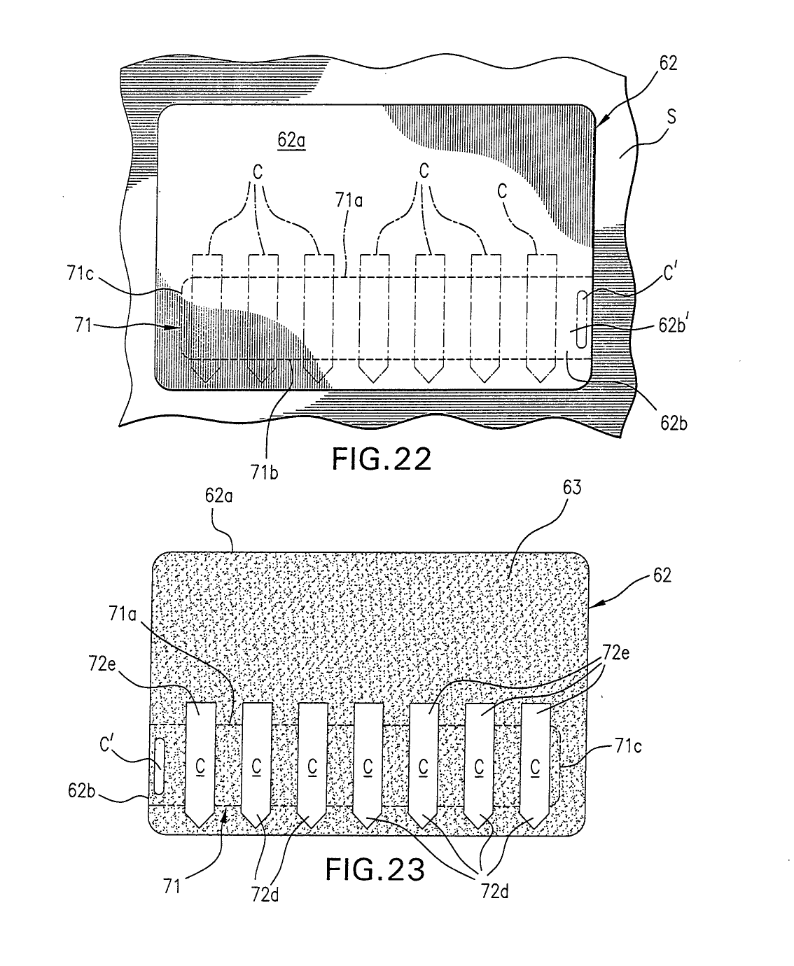

With reference to FIG. 21, a label 62 is shown to have been printed with bar codes and text and peeled from release liner section 61a and adhered to the substrate S. No hidden lines are shown in FIG. 21 for clarity. FIG. 22, however, shows the label 62 adhered to the substrate S with hidden lines, but with the printing omitted for clarity.

The second label section 62b can be removed from the first label section 62a by the user grasping end portion 62b′ and the chad C′ between the thumb and index finger of one hand and tearing the second label section 62b along lines 71a and 71b progressively and then along line 71c. Because the end portions 72d and 72e of the chads C are retained captive beneath the first label section 62a, the chads C stay with the first label section 62a and the substrate S while the second label section 62b and the chad C′ are removed as a unit.

FIG. 23 shows the underside of the label 62 shown in FIG. 22 and it shows the chads C and C′ adhered to the adhesive 63.

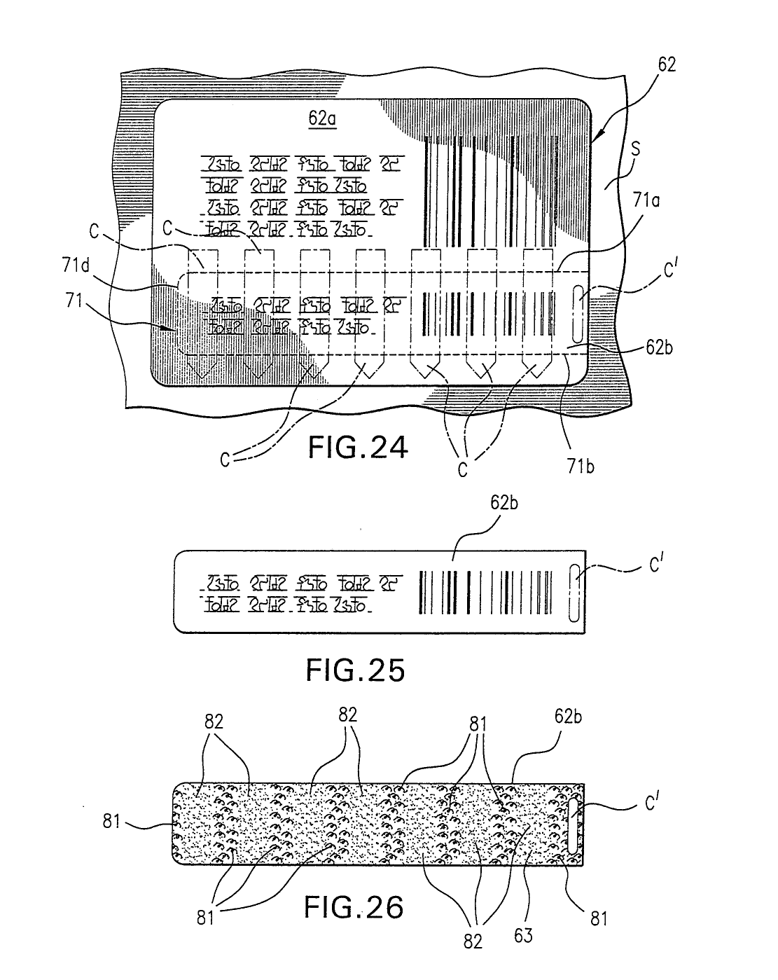

FIG. 24 combines FIGS. 21 and 22, showing printing, dot-dot weakening line 71 and hidden chads C and C′ shown by hidden dot-dash lines.

FIG. 25 is a top plan view of a second label section 62b as having been removed from the substrate S, the first label section 62a and chads C.

FIG. 26 is a bottom plan view of the second label section 62 shown in FIG. 25. It is noted that areas 81 of the second label section 62b which had been adhered to the substrate S are areas where fibers from the substrate S still remain adhered to the adhesive 63. Accordingly, the fibers in the areas 81 provide a partial masking affect so that the adherence of the adhesive 82 in the areas 81 is not as great as the areas 82 of unused adhesive 63. Because the areas 82 were protected by the chads C the holding power or adhesivity of the adhesive 63 in the areas 82 is undiminished.

Although the lines of weakening 71 and the lines of severing 72 and 73 are grouped but are not aligned with each other, the lines 71, 72 and 73 are registered with each other, with the labels 62 and with the lines of weakening 64.

It is readily apparent that the composite label web 60 is the embodiment of FIGS. 18 through 26 is useable in an automatic printer applicator so that, for example, cartons 30 passing along a conveyor can be labeled, while still retaining the ability of the second label section to be removed from the first label section of the label applied to the carton, without removing the protective chads C. Accordingly, because the chads C remain with the first label section and the carton 30, there is no need to strip the chads C from the second label section 62b or to dispose of the chads, yet the second label sections 62b retain enough unused adhesive 63 to retain the reapplied second label section 62b securely to the substrate S.

Although seven chads C are illustrated a greater or lesser number may be provided. Also, other and different sizes of chads can be used.

While reference is made to “first”, “second” and “third” herein for clarity of expression, there is no intention to thereby limit the scope of the claims. For example, the “first label section” could well have been designated the second label section, and the second label section could then have been designated the first label section, and so on.

Other embodiments and modifications of the invention will suggest themselves to those skilled in the art, and all such of these as come within the spirit of this invention are included within its scope as best defined by the appended claims.

I claim:

1. A composite label, comprising:
a label having a coating of pressure sensitive adhesive on its underside, the label having a first label section and a second label section defined by at least one line of weakening,
at least one release liner section against only a portion of the adhesive so that adhesive beyond the release liner section(s) may adhere the label to a substrate, the release liner section(s) underlying at least a part of the second label section,
the first label section overhanging and capturing only a portion of the second release liner section(s), and wherein the second label section may be separated from the first label section without removing the first label section or the release liner section(s).

2. A composite label as defined in claim 1, the release liner section(s) having a generally elongate configuration.

3. A composite label as defined in claim 1, wherein the release liner section(s) comprise a release liner section adjacent an edge of the second label section to facilitate separation of the second label section from the first label section.

4. A composite label as defined in claim 1, wherein the line of weakening comprises perforations.

5. A composite label, comprising:
a release liner having a first release liner section and at least one second release liner section,
a label releasably adhered by pressure sensitive adhesive to the first and second release liner sections, the label having separable first and second label sections, and the first label section overhanging and capturing at least a portion of at least one second liner section.

6. A composite label as defined in claim 5, wherein the second label section is elongate, wherein the second release liner section(s) are elongate, and wherein the second release liner section(s) is (are) wider than the second label section.

7. A composite label web as defined in claim 5, wherein the first and second release liner sections are defined by a generally U-shaped line of severing.

8. A composite label as defined in claim 5, wherein the second label section is elongate, wherein there are a plurality of elongate second release liner sections, and wherein the second release liner sections are each narrower than the second label section.

9. A composite label, comprising:
a label having a coating of pressure sensitive adhesive and divided at least into a first label section and a second label section removable with respect to the first label section, and
at least one release liner section under at least part of the second label section and captive under only a part of the first label section.

10. A composite label web, comprising:
a longitudinally extending release liner,
labels releasably adhered by pressure sensitive adhesive along the length of the release liner,
the release liner being severed in registry with each label to divide the release liner beneath each label into a first release liner section and at least one second release liner section,
each label being at least partially severed to divide each label into at least a first label section and a second label section removable from the first label section,
wherein the longitudinal extent of at least a part of one second release liner section is greater than the longitudinal extent of the second label section,
wherein when the first release liner section has been removed from the label, and the label and the second release liner section(s) have been applied to a substrate, the second label section is removable without removing the second release liner section(s).

11. Method of using a composite label:
providing a composite label including a release liner having a first release liner section and at least one second release liner section, wherein the first release liner section is substantially severed from the second liner section(s), and a label releasably adhered by pressure sensitive adhesive to the first and second release liner sections, the label having separable first and second label sections, the first label section overhanging only a portion of the second liner section(s),
printing information on the first and second label sections,
removing the first release liner section to expose adhesive beneath a part of the first label section,
attaching the label and the at least one second liner section to a substrate, and
thereafter removing the second label section but retaining the at least one second liner section captured by the first label section.

12. Method as defined in claim 11, wherein there are at least two second release liner sections, wherein one of the second release liner sections is disposed near an edge of the second label section to facilitate grasping and removal of the second label section.

13. Method of using a composite label web:
providing a label on a release liner having a first liner section and at least two second release liner sections, the label being releasably adhered by pressure sensitive adhesive to the first release liner section and the at least two second release liner sections, the label having at least first and second separable label sections, the first and second release liner sections being at least substantially severed from each other,
separating the label and the second release liner section from the first release liner section in a label applicator,
applying the label and the second release liner sections to a substrate, and
thereafter removing the second label section from the substrate without removing the second release liner sections.

14. Method of using a composite label web:
providing a label on a release liner having a first liner section and at least one second release liner section, the first and second release liner sections all being severed from each other, the label being releasably adhered by pressure sensitive adhesive to the first and second release liner sections, the label having at least first and second separable label sections,
separating the label and the second release liner section(s) from the first release liner section in a label applicator,
applying the label and the second release liner section(s) to a substrate, and
thereafter removing the second label section from the substrate without removing the second release liner section(s).
